(19) United States
(12) Patent Application Publication
(10) Pub. No.: US 2006/0260830 A1
(43) Pub. Date: Nov. 23, 2006

(54) Percussion device for a hand machine tool

(76) Inventor: Friedmar Dresig, Chemnitz (DE)

Correspondence Address: Striker Striker & Stenby, 103 East Neck Road, Huntington, NY, 11743, US

(21) Appl. No.: 10/547,983

(22) PCT Filed: Sep. 3, 2004
(86) PCT No.: PCT/DE04/01957

§ 371 Date: Sep. 8, 2005

(30) Foreign Application Priority Data
Oct. 17, 2003 (DE) 103 48 397.7

(51) Int. Cl. B25D 11/00

(52) U.S. Cl. 173/201; 173/216

(57) ABSTRACT

A hammer mechanism for a hand-guided machine tool, in particular for a rotary hammer, percussion hammer, or impact drill, has a drive piston (11), which is supported so that it is able to move axially in a guide tube (13) and is able to be motor driven via a gear mechanism (17) into a reciprocating, axial stroke motion, and has a hammer that is contained in an axially movable fashion in the guide tube and acts on a tool and, together with the drive piston (11), delimits a compression chamber in which an air cushion is enclosed. In order to be able to freely embody the chronological curve of the stroke path of the drive piston (11) for optimization purposes, e.g. to reduce pressure peaks in the compression chamber, the gear mechanism (17) has two meshing nonround gears (18, 19), whose rotation axes (20, 21) are situated a fixed distance (a) apart from each other. The one driving nonround gear (18) is able to be motor driven and the other nonround gear (19), which is driven by the driving nonround gear (18), has a piston rod (23), which is connected to the drive piston (11), linked to it, eccentrically in relation to its rotation axis (21) (FIG. 2).

### PRIOR ART

The present invention is based on a hammer mechanism for a hand-guided machine tool, in particular for a rotary hammer, percussion hammer, or impact drill according to the preamble to claim 1.

In a known hand-guided machine tool, e.g. a rotary hammer or percussion hammer (DE 35 11 437 A1), the drive piston that can slide axially in the guide tube is linked by a connecting rod to a crank pin of a crankshaft that can be driven via a pinion gear mechanism by the drive shaft of an electric motor. When the electric motor is switched on, the cranking action sets the drive piston into a reciprocating motion. The stroke motion of the drive piston over time describes an approximately sinusoidal curve. With the stroke motion of the drive piston, an excess pressure and a negative pressure are generated in alternating fashion in the compression chamber between the drive piston and the hammer, which accelerates the hammer in the direction of the tool. The chronological progression of the pressure in the compression chamber ensues from the relative distance between the drive piston and the hammer and is determined by the sinusoidal curve of the drive piston stroke. The pressure progression is characterized by a temporary, high peak value and a relatively long interval of time with a low pressure. The principle pressure progression is depicted by curve a in FIG. 3.

The high peak pressure in the compression chamber results in a powerful load on the compression chamber and to a relatively high cost of sealing the compression chamber in the guide tube, which increases disproportionately as the pressure increases. The pressure progression in the compression chamber caused by the sinusoidal stroke of the drive piston also results in the fact that the drive energy provided by the drive piston is not effectively used for a uniform exertion of pressure on the hammer and as a result, the optimum hammer speed for a rapid drilling progress is not achieved.

### ADVANTAGES OF THE INVENTION

The hammer mechanism for a hand-guided machine tool according to the present invention, with the characterizing features of claim 1, has the advantage that the noncircular gear pair is able to set almost any curve of the stroke path of the drive piston, depending on how the rolling curves of the two gears are designed. The design of the rolling curves depends exclusively on the optimization goal. The rolling curves can, for example, be calculated so that a maximum speed is imparted to the hammer with a minimum exertion of pressure in the compression chamber. The rolling curves can also be calculated so that with a minimal exertion of pressure in the compression chamber and simultaneously high speed of the hammer, only a minimal drive moment is required for the drive piston. In addition to these examples, other optimization goals can be met by means of the rolling curve design. The principal goal of the rolling curve design is the imparting of a powerful energy to the tool with a low consumption of power, i.e. a significant increase in efficiency.

Advantageous modifications and improvements of the hammer mechanism disclosed in claim 1 are possible by means of the steps taken in the remaining claims.

### DRAWINGS

The present invention will be explained in greater detail in the description below in conjunction with an exemplary embodiment shown in the drawings.

FIG. 1 shows a partially cutaway view of a hammer mechanism for a hand-guided machine tool,

FIG. 2 is a perspective view of the drive piston and gear mechanism of the hammer mechanism shown in FIG. 1, and

FIG. 3 is a graph of the chronological pressure progression in the compression chamber of the hammer mechanism in the prior part (curve a) and in the hammer mechanism according to the present invention (curve b).

### DESCRIPTION OF THE EXEMPLARY EMBODIMENT

The schematically depicted, partially cutaway hammer mechanism for a hand-guided machine tool shown in FIG. 1, e.g. for a rotary hammer, percussion hammer, or impact drill, has a drive piston 11 and a hammer 12 that are situated axially one after the other in a guide tube 13 and guided therein in an axially movable fashion. The end surfaces of the drive piston 11 and the hammer 12 oriented toward each other delimit a compression chamber 14 in the guide tube 13 in which an air cushion is enclosed. The guide tube 13 is contained in a housing, not shown here, of the hand-guided machine tool. The axis of the guide tube 13 coincides with the axis of a tool socket that holds part of a tool, e.g. an impact drill bit. The tool either protrudes with its tool shaft into the guide tube 13 or, as shown here, is axially flush with a hammer pin 15 that is guided in an axially movable fashion in the guide tube 13.

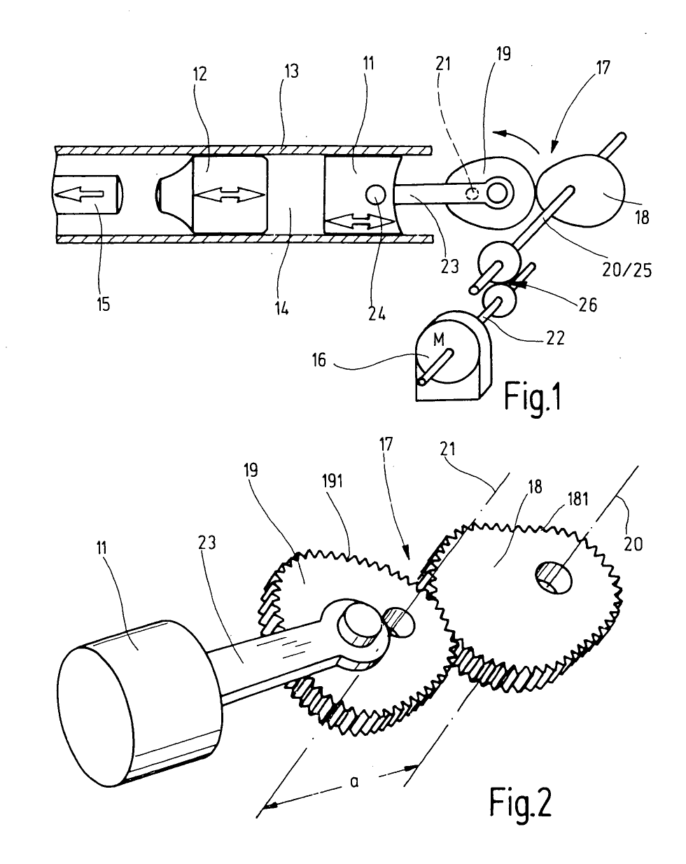

The housing of the hand-guided machine tool contains an electric motor 16, which, by means of a gear mechanism 17, sets the drive piston 11 into a reciprocating, axial stroke motion in the guide tube 13. The gear mechanism 17 has two meshing nonround gears 18, 19, one of which is a driving nonround gear 18 and the other of which is a driven nonround gear 19. Each nonround gear 18, 19 has a rotation axis 20, 21. The two rotation axes 20, 21 are situated a fixed distance a apart from each other. In the exemplary embodiment shown, the driving nonround gear 18 is supported in a rotationally fixed manner on a countershaft 25 supported in the housing and an intermediate gear mechanism 26 is situated between the drive shaft 22 of the electric motor 16 and the countershaft 25. The driven nonround gear 19 is supported so that it can rotate around its rotation axis 21 in the housing. Eccentric to the rotation axis 21, the nonround driven gear 19 has a piston rod 23 embodied in the form of a crank or connecting rod linked to it, which is connected to the drive piston 11 in a pivoting fashion. The end of the piston rod 23 oriented toward the piston engages with a rotating pin 24 that is accommodated inside the end of the drive piston 11 oriented away from the compression chamber 14, extending transversely in relation to the axis of the guide tube 13. The drive piston 11 is shown in its one stroke end position in FIG. 1 and in its other stroke end position in FIG. 2.

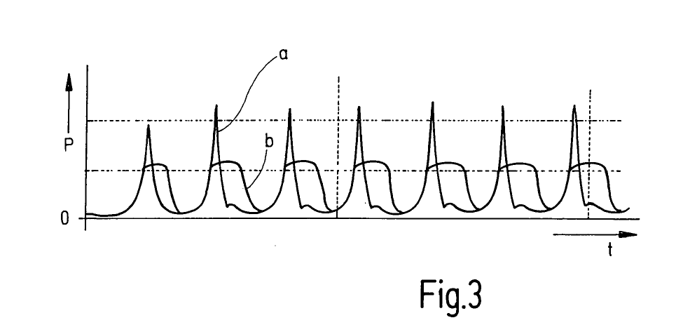

When the electric motor 16 is switched on, the drive piston 11 is set into a reciprocating, axial stroke motion by means of the gear mechanism 17; the air cushion in the compression chamber 14 is compressed and decompressed in alternating fashion. The compression pressure accelerates the hammer 12 and imparts its energy to the tool via the hammer pin 15. The chronological progression of the pressure in the compression chamber 14 depends on the relative distance between the drive piston 11 and the hammer 12 and is essentially determined by the chronological curve of the stroke of the drive piston 11. In order to be able to achieve an optimized distance/time curve of the drive piston 11, the rolling curves 181 and 191 of the nonround gear 18 and the nonround gear 19, which have the same number of teeth, are embodied so that the stroke path the drive piston 11 describes the desired chronological progression. One optimization option is to calculate the rolling curves 181, 191 of the two nonround gears 18, 19 so that a maximum speed is imparted to the hammer 12 with a minimal exertion of pressure in the compression chamber. In FIG. 3, the curve b represents the chronological pressure progression in the compression chamber 14 with such an embodiment of the two nonround gears 18, 19. As is clearly visible, in comparison to the pressure progression according to curve a, which is achieved with a conventional, approximately sinusoidal stroke motion of the drive piston 11 according to the prior art, the pressure peaks are reduced and a more uniform pressure distribution over a longer period of time is achieved. The high hammer speed is therefore maintained.

With the novel gear mechanism, through a corresponding embodiment of the rolling curves 181, 81 of the nonround gears 18, 19, depending on the optimization goal, it is possible to achieve a favorable drilling progress or chisel cutting, a reduced power consumption, and a more uniform current consumption. The hand-guided machine tool experiences a low degree of vibration on the whole.

What is claimed is:

1. A hammer mechanism for a hand-guided machine tool, in particular for a rotary hammer, percussion hammer, or impact drill, having a drive piston (11) that is supported so that it is able to move axially in a guide tube (13) and is able to be motor driven via a gear mechanism (17) into a reciprocating, axial stroke motion, having a hammer (12) that is contained in an axially movable fashion in the guide tube (13) and acts on a tool, and having a compression chamber (14) delimited by the drive piston (11) and hammer (12) in which an air cushion is enclosed,
wherein the gear mechanism (17) has two meshing nonround gears (18, 19), whose rotation axes (20, 21) are situated a fixed distance (a) apart from each other; the one driving nonround gear (18) is able to be motor driven; and the other nonround gear (19), which is driven by the driving nonround gear (18), has a piston rod (23), which is connected to the drive piston (11), linked to it, eccentrically in relation to its rotation axis (21).

2. The hammer mechanism as recited in claim 1,
wherein the rolling curves (181, 191) of the two nonround gears (18, 19) are situated so that the stroke path of the drive piston (11) has a desired chronological progression.

3. The hammer mechanism as recited in claim 2,
wherein the chronological progression of the stroke path of the drive piston (11) is established so that it is possible to achieve a high hammer speed with a minimal compression pressure in the compression chamber (14).

4. The hammer mechanism as recited in claim 2,
wherein the chronological progression of the stroke path of the drive piston (11) is established so that it is possible to achieve a high hammer speed with a minimal consumption of electrical energy.

5. The hammer mechanism as recited in claim 1, wherein the two nonround gears (18, 19) have the same number of teeth.
